(19) United States
(12) Patent Application Publication
(10) Pub. No.: US 2017/0126686 A1
(43) Pub. Date: May 4, 2017

(54) System and Method for Managed Access to Electronic Content

(71) Applicant: WikiEye EAD, Sofia (BG)

(72) Inventor: Todor Yotkov Totov, Sofia (BG)

(73) Assignee: WikiEye EAD, Sofia (BG)

(21) Appl. No.: 15/342,609

(22) Filed: Nov. 3, 2016

Related U.S. Application Data
(60) Provisional application No. 62/250,117, filed on Nov. 3, 2015.

(51) Int. Cl. H04L 29/06; G06F 17/30

(52) U.S. Cl. CPC H04L 63/101; H04L 63/105; G06F 17/30867

(57) ABSTRACT

A method comprising steps: (a) receive a request from a user instance for access to identifiable and indexable content; (b) perform a first check whether the content is part of a pre-defined volume of resources which the user instance is allowed to access; (c) allow the user access to the content only if there is a specific match between the identifier of the content or its repository; (d) perform a second check if the user is allowed to access the content; and (e) apply content pre-processing and deliver the content as prescribed by a general pre-defined settings for content delivery, format, and visualization to the user applicable to the particular user instance.

### CROSS-REFERENCE TO RELATED APPLICATIONS

The present application claims priority to U.S. Provisional Patent Application Ser. No. 62/250,117, filed on Nov. 3, 2015 entitled “System and Method for Managed Access to Electronic Content”, the disclosure of which is hereby incorporated in its entirety at least by reference.

### BACKGROUND OF THE INVENTION

1. Field of the Invention

The present invention relates generally to the field of electronic content monitoring and analysis and to methods and systems for selective access to electronically transmitted content based on pre-defined user criteria and for providing search capabilities within the selected content. More specifically, the disclosure relates to methods and systems for allowing managed access to electronic content based on dynamically updated lists with access preferences and prescribed sequences, for filtering of the content served on the user end device or via an electronic network, and for providing comprehensive search functionalities within the pre-defined sets of allowed resources that also limit the user-accessible result descriptions or previews only to results from the content resource lists allowed for the particular user or network.

2. Description of Related Art

With the ubiquity of internet access and use, parents and guardians are under constant pressure to allow their children access to the internet from a very early age. The entry age for children having their own devices with internet access is also constantly declining. More often than not it is taken as a given that a kid in a school age has access to internet content which impacts how educators and caretakers structure their curricula and approach home assignments and autonomous work. This trend is augmented by the Bring-your-own-device policy widely embraced for adoption by educational institutions globally. The ensuing problem with limiting the access to age-appropriate content only is today being addressed by a wide variety of technological vendors primarily by application of:
a. Age categories for different types of content;
b. Blacklisting of websites, keywords and phrases, and categories of web content for the limited types of entries where this is somewhat developed. Implementing firewalls and complex content filtering solutions on a single user or an entity level (e.g., school, campus, etc.) generally falls within the same category; and
c. Whitelisting of websites which effectively limits the access to a pre-selected list of web addresses.

The major challenges with the above three approaches can be summarized as follows:
a. Age categorization is primarily developed for entertainment content (movies, games) and there is no comprehensive general rating for websites and platforms beyond the adult/explicit material category which has gotten a lot of attention and efforts throughout the years;
b. Blacklisting has gotten most of the attention and investment from anti-virus, parental controls, OS, platform and general application vendors, but the approach has proven to have severe drawbacks in terms of comprehensiveness, time lags for updates and security against websites and content ‘slipping’ through the filters. Moreover, in terms of having visibility on the age appropriateness of the web content served on a user device, the world wide web is getting more and more ‘tangled’ and opaque with the wide acceptance of website redirects, pop-up windows, user consent dialogue layers, embedded flash and scripts, and other content redirects and easy-to-implement content implants.
c. Without a significant investment in creating template whitelists that comprehensively cover all categories that a child in the relevant age group social environment and cultural setting would normally access without the whitelisting limitations, both the parents/guardians and the child end frustrated. This is due to the overly-restrictive approach and the technical complexity hurdles to applying guardian's discretion to such a wide universe of topics and sources and then technically implementing it on a device or on a program or browser level.

A major issue that is not comprehensively addressed is caused by the websites, platforms and applications that have built-in search functionalities or that allow for internal redirects to other websites which are often omitted by most of the current solutions for virus protection, AV, parental controls, firewall or content filtering, etc. In the standard scenario, a whitelisted or a non-blacklisted website has one of said functionalities and even if the access to certain pages is restricted in one way or another, previews of results or search result snippets are displayed on the user device which very often reveals information and displays digital content that is outside of the pre-set limitations. This can be experienced with all major search engines for example.

The proliferation of image, video and streaming video platforms is another trend where current solution vendors are well in arrears and very often major solutions that used to work until recently are rendered useless by said accessibility to visual content. Another issue of concern is that even the most widely used and reputable education and encyclopedia-type platforms have not implemented robust rating mechanism for published content which has brought us to the current state where educational articles contain photos inappropriate for school-age kids, or mix educational content with obscenities. The list with challenges can go on and on and a lot of market players, public programs and non-profits are putting efforts in keeping up with the technological advancements and in searching for a comprehensive solution to what is generally termed ‘kid's online safety’. The above is only one example of the limitations of the blacklisting approach if one wants to adopt a robust policy for providing access to online resources and content based on pre-defined criteria. In the example above the criteria set is focused at age restrictions. However, more and more often agents strive to adopt policies for internet content access following custom case-specific criteria that can then be adopted within a certain network; on a device level, operating system or application level.

Most importantly, the challenges with providing usable results mapped to pre-defined criteria are not limited only to securing that no results outside the pre-set limitations are served to the end user. A major hurdle to the usability of any internet search solution is the sheer number of results from even the basic searches and the resulting overwhelming size of result lists. Users struggle to make meaning out of the cluttered pile of entries they get as a result from the searches. The latter is widely acknowledged but the efforts of the major search engines are naturally focused on providing results grouping that can be fully automated such as grouping by file time, by date, or by a very general grouping criterion that still leaves the user with predominantly irrelevant results.

### BRIEF SUMMARY OF THE INVENTION

In one embodiment of the present invention a method is provided, comprising steps: (a) receive a request from a user instance for access to identifiable and indexable content, or an electronic data repository, a document or another uniquely identifiable data piece accessible via electronic networks, wherein the content is a web resource or an electronic data repository; (b) perform a first check whether the content is part of a pre-defined volume of resources which the user instance is allowed to access, wherein the allowed volume of resources is stored and analyzed in the form of one or more whitelists that can be used in provisioned or non-provisioned sets or overlays; (c) allow the user access to the content only if there is a specific match between the identifier of the content or its repository and an identifier on the whitelists for the user instance; (d) perform a second check if the user is allowed to access the content, wherein the second check determines if the content is part of a pre-defined set of restrictions applicable to the user instance, wherein the set of restrictions is any piece or volume of identifiable electronic content stored and analyzed in the form of one or more blacklists or blacklist routines that can be used in provisioned or non-provisioned sets or overlays; and (e) apply content pre-processing and deliver the content as prescribed by a general pre-defined settings for content delivery, format, and visualization to the user applicable to the particular user instance.

In one embodiment, further comprising step (f) deny access to the content as prescribed by the one or more blacklist routines when the user is not allowed access to the content as performed by the second check. In one embodiment, the user instance is a set of user preferences, routines, and credentials linked to a particular individual, end user device, computer system, network device, identifiable network, or cluster. In another embodiment, further comprising step (g) if any type of a search functionality is used allow the user instance visibility and access only to indices, summary information, snapshots, resumes or snippets of the content that is on the user's one or more whitelists. In yet another embodiment, the one or more whitelists and blacklists are pre-defined by a user, a system, an application administrator, or by a computer process executing a set of routines that are a programmatic implementation of objective and subjective criteria for content identification, analysis, sorting, and filtering. In one embodiment, the request results can be grouped by dynamic or pre-defined criteria for context, type, geography, chronology, language, or another criterion defined by a user, by an administrator or by a machine setting, process or workflow.

In another aspect, a system is provided, comprising: a Network-connected server containing a processor capable of executing instructions stored on a computer-readable storage medium, the processor executing end user software tools for allowing managed access to electronic content, the system enabling a user via an electronic device to: (a) select a First-level identifier, wherein a first list of results is presented based on the First-level identifier selection; (b) input a search term through an electronic input device, wherein a second list of results is presented; (c) wherein any list of results contains search results or summary information, snapshots, resumes or snippets of search results only from content that is on the user's one or more whitelists; (d) select a result from the first or second list of results; and (e) access the electronic content from the selected result.

In one embodiment, the second list of results is the first list of results that contain the search term. In another embodiment, the second list of results is the user's whitelist that contain the search term. In yet another embodiment, the electronic device includes a second processor capable of executing instructions stored on a second computer-readable storage medium, and the electronic device are subject to system restrictions. In one embodiment, the second computer-readable storage medium stores records on whitelists, blacklists, and routines for the access to the electronic content, and the system checks the second computer-readable storage medium to see if the user is allowed or denied access to the electronic content. In another embodiment, the first computer-readable storage medium stores records on whitelists, blacklists, and routines for the access to the electronic content, and the system checks the first computer-readable storage medium to see if the user is allowed or denied access to the electronic content.

### BRIEF DESCRIPTION OF THE SEVERAL VIEWS OF THE DRAWINGS

Other features and advantages of the present invention will become apparent when the following detailed description is read in conjunction with the accompanying drawings, in which:

FIG. 1 is a diagram of an exemplary system for allowing managed access to electronic content to user instances, in accordance with an embodiment.

FIG. 2 shows an exemplary flow chart that includes steps taken by the user to access the content that the particular user instance is allowed to, in accordance with some embodiments; and

FIG. 3 shows an exemplary flow chart that includes steps executed at the server end for processing a content access request by a user instance and for applying the user-specific whitelist, blacklist and content delivery limitations and provisions stored on the system, in accordance with some embodiments.

FIGS. 4-9 show an outline of an exemplary non-limited embodiment of the present invention with a non-exhaustive high-level walkthrough of the functionalities, in accordance with some embodiments.

FIGS. 10 and 11 show some functionalities of an administrative panel for a system administrator in accordance with some embodiments.

### DETAILED DESCRIPTION OF THE PREFERRED EMBODIMENT

The following description is provided to enable any person skilled in the art to make and use the invention and sets forth the best modes contemplated by the inventor of carrying out their invention. Various modifications, however, will remain readily apparent to those skilled in the art, since the general principles of the present invention have been defined herein to specifically provide a system and method for managed access to electronic content.

The present invention is directed to a system and method for managed access to electronic content. Reference will now be made in detail to the present exemplary embodiments, examples of which are illustrated in the accompanying drawings. Wherever possible, the same reference numbers will be used throughout the drawings to refer to the same or like system parts and process steps.

The present invention advantageously fills the aforementioned deficiencies of the prior art by providing a system and method for managed access to electronic content which provides a robust and universally deployable overlay of routines for whitelisting of available resources and of further dynamic filtering of the content served on user devices based on blacklist-type restrictions.

The present invention consists of a method together with an associated computer process that is made up of the following executable steps, all of which are required in all versions: (1) receive a request for access to a web resource or an electronic data repository whereby electronic content or the path to electronic content or meta description of electronic content is stored and accessed in uniquely identifiable and indexable fashion; (2) wherein said request is coming from a user instance that can represent a set of user preferences, routines and credentials linked to a particular individual, end user device, computer system, network device or an identifiable network or cluster in the broadest sense; (3) perform a check whether the requested content or resource is part of a pre-defined volume of resources which the particular user instance is allowed to access, said volume of allowed resources stored and analyzed in the form of one or more whitelists that can also be used in provisioned or non-provisioned sets or overlays; (4) allow the user access to the requested resource only if there is a specific match between the identifier of the content or its repository and an identifier on the whitelists for the particular user instance; (5) if the user instance is allowed to access the requested content—perform a check whether any element of the requested content is part of a pre-defined set of restrictions applicable to the particular user instances said restrictions referring to any piece or volume of identifiable electronic content and stored and analyzed in the form of one or more blacklists or blacklisting routines that can also be used in provisioned or non-provisioned sets or overlays; (6) apply content pre-processing and deliver the requested content or deny access to the requested content as prescribed by the blacklisting routines and by the general pre-defined settings for content delivery, format and visualization at user's end applicable to the particular user instance; (7) in case any type of a search functionality is used—allow the particular user instance visibility and access to indices, summary information, snapshots, resumes or snippets only of resources and content that is on the user's whitelists within the meaning of step (2) above. Other aspects of this invention relate to a computer program and an apparatus corresponding to the method previously described.

Implementations of the present invention may include one or more of the following features. The whitelists and the blacklists can be pre-defined by a user, by a system or application administrator, or by a computer process executing a set of routines that are the programmatic implementation of objective and subjective criteria for content identification, analysis, sorting and filtering. The same can be implemented for the routines for serving the requested content to the user (such as content filters, ad blockers, settings for page redirects, depth parameters, etc. preferences). The logic of combining whitelisting of available resources and blacklisting during the content delivery and visualization phase can be easily applied to communication solutions such as mail servers for example. In the latter case whitelist preferences and provisioning can be applied on a sender/recipient level, attachment type, content, context and any output, from standard content processing routines or from neural networks, self-learning algorithms, artificial intelligence or artificial instinct systems. The results from any search or content request can be grouped by dynamic or pre-defined criteria for context, type, geography, chronology, language, or another criterion defined by a user, by an administrator or by a machine setting, process or workflow. One example of the latter in the context of internet searches is the option to have counters pointing at the total number of results from the same Top Level Domain or Host, or to have result containers with similar entries or any taxonomy and grouping of results that can be input and processed via electronic means.

The present invention is superior when compared with other known solutions in that it provides an overlay of the strict limitations to the access to electronic resources and content (access only to whitelisted resources and content) and the multi-layered prescriptions for filtering and provisioning of the information delivery based on the actual content at the resource at the moment of serving it to the user (blacklists and content recognition, processing, analysis and filtering as per the pre-defined rules applicable to the specific user). The invention also advantageously provides the security that users shall have access to previews, snippets and identifiable descriptions of results only from whitelisted resources, which is particularly valuable in the context of stand-alone or embedded internet search functionalities.

The present invention is unique in that it is different from other known processes or solutions. More specifically, the present invention overcomes the limitations to the content filtering and to the provisioning of resource and content access by blacklisting of resources known at the time of the latest administrator setup, and provides a resolution to the challenges of dynamically altered content at source, of resource redirects and, in the context of web content delivery, of in-page searches and preview of search results. Furthermore, in one embodiment the method and system herein presented propose an unique solution where all access to the pool of generally available resources is executed through the system servers and all filtering and content processing applicable to the respective user instance is done at the system servers. The latter enables deployment where what is generally thought of as user instance can in practice be any end user device, network, cluster, cloud or a subset or grouping of those. In that way the user preferences shall be effective for all levels down the network topology.

Among other things, it is an object of the present invention to provide a system and method for managed access to electronic content that does not suffer from any of the problems or deficiencies associated with prior solutions.

It is still further an object of the present invention to allow for a robust implementation of any content identification, logical criteria assignment and criteria-based delivery sequences. The method and system provide those skilled in the art with leverage and flexibility in addressing the challenges of serving relevant content to the users in a machine-operated way. The objective of providing information relevance through dynamically managed granular breakdowns of the available data and serving content that is specifically identified by discrete pre-set criteria goes far beyond the narrower mandate of content appropriateness in its standard sense.

Further still, it is an object of the present invention to enable this triple mandate of real-time filtering for appropriateness, relevance and security to be deployed on any type of network or network hub device in order to reach well identified subsets of the network. The latter allows for applying the limitations to schools, enterprise networks, societies, geographic regions, etc.

Embodiments of the invention may be implemented to allow a user instance (such as an end user or a uniquely identifiable electronic device, network or a network adapter) to request access to electronic content via standard network means, and such request to be allowed or denied based on pre-defined lists of allowed content pieces and accessible addresses where electronic content is stored, and on pre-defined criteria for analyzing and processing of the electronic content before serving it to the user instances in a modified or unmodified form. Said lists and criteria loosely referred to as whitelists and blacklists, respectively, can be pre-defined by system administrators or by procedures or workflows executable by machine, or can be assigned by a class of users that have administrative rights with respects to the permission management for a list of end user instances. The electronic content can include a web site or an application, such as a chat program, email, music, game, or some other tool, a file, file structure or directory or any other segregated information volume that is queried and accessed by a uniquely identifiable network address.

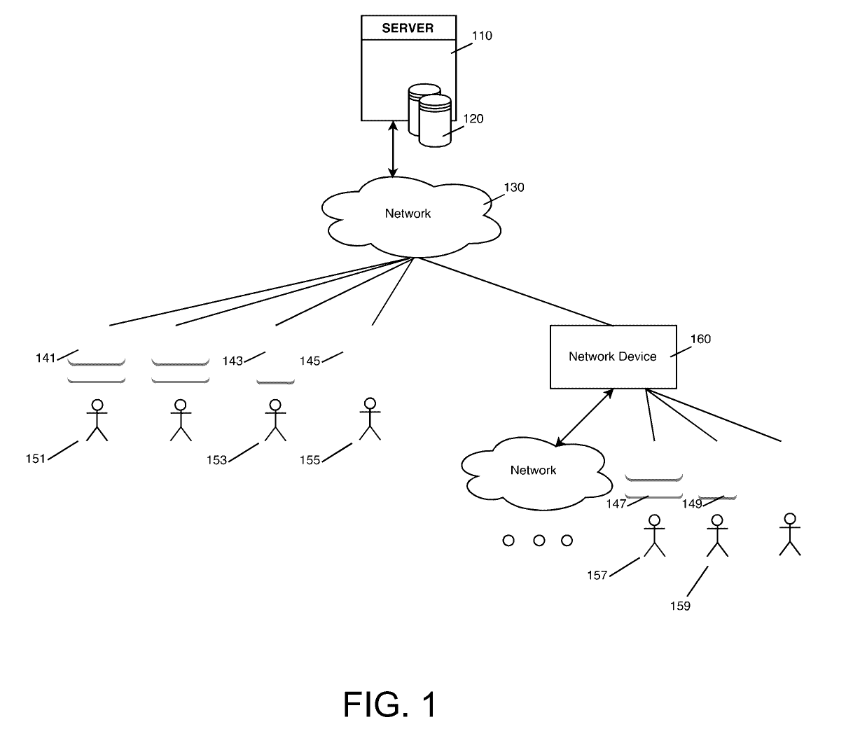

FIG. 1 is a diagram of an exemplary system for allowing managed access to electronic content to user instances, in accordance with some embodiments. User instance devices 141, 143 and 145 are operated by users 151, 153 and 155. The devices 141, 143 and 145 may be electronic devices with access to the Network 130 which can be the Internet and/or other wired or wireless networks, further communicating with the server 110 with database 120. The devices 141, 143 and 145 can be any electronic devices capable of accessing electronic content, such as a personal computer, laptop, cell phone, smart phone, tablet, wearable smart device, personal media player, or a similar device. Generally, the devices 141, 143 and 145 may include a processor capable of executing instructions stored on a computer-readable storage medium, such as a disk, CD, DVD, RAM, flash memory, or any other known memory or electronic storage medium. The devices 141, 143 and 145 are operated by users 151, 153 and 155 whose access to electronic content is subject to the system restrictions and setups for the corresponding user instance. The restricted content may be content from a particular Web site or URL, or may comprise files or other structured data volumes or communication pieces for download and/or dynamic access via the Network 130. Web servers and other sources for providing such content are not illustrated in FIG. 1.

In one embodiment, the devices 141, 143 and 145 store records on whitelists, blacklists and routines for electronic content delivery locally. One implementation allows the devices 141, 143 and 145 to maintain local databases, and check the local databases to see if the respective user 151, 153 or 155 is allowed or denied access to particular content, and if a local decision can be reached, further communications with the server 110 may not be necessary. In another embodiment, the whitelists, blacklists and routines for electronic content delivery records are not stored locally but reside on the server 110. In yet another embodiment, such records are not organized in data sets or databases that contain the full whitelist, blacklist and electronic content delivery routines for the user but rather the system keeps track only of the incremental changes to master records whitelist, blacklist and content delivery routines records that are applicable to each user instance, and stores those locally on the user devices or on the server.

In one embodiment, the system allows for treating a whole network, cluster, an end user group and/or the network device serving as the connection hub to such network, cluster or an end user group to be setup and treated as a user instance. Network Device 160 represents such a network hub where the user instance whitelists, blacklists and electronic content delivery routines are applied to all devices and networks behind Network Device 160. Further user provisioning that is subordinate to the limitations and preferences for the user instance of Network Device 160 can be applied for devices 147 and 149 and users 157 and 159. Network Device 160 can be any router, brouter, gateway, CSU/DSU, WAP or another electronic network device. In another embodiment, the limitations and preferences for the user instance of Network Device 160 are automatically and indiscriminately applied for all levels down the network topology. Server 110 can include one or more servers and/or other communicatively-coupled components. In one implementation, server 110 is in communication with database 120, which can be comprised of one or more databases and subsystems, and also contains a processor capable of executing instructions stored on a computer-readable storage medium. Server 110 can be automatically accessed by the user instance through the Network 130, via end user software tools devised to work specifically with the system or via standard web browsers, ftp clients and other standard applications for retrieving, presenting and traversing information resources on a computer network. Server 110 receives an electronic content access request from a user instance device such as 141, 143, 145 or 160. The request includes information that allows the server 110 to determine a content identifier in database 120 associated with the content that the user instance wishes to access. Additionally, the request includes information for unique identification of the user instance. In one embodiment, the information includes the content identifier and the user instance identifier. In another embodiment, the information may include an account number that can be relationally linked to the user instance identifier in database 120. Similarly, the content identifier may be determined by extracting a portion of a URL or a network address and locating the content identifier in the database 120 that is related to the URL. In one aspect, the URL itself or the network address is the content identifier.

In another embodiment, the content identifier is a unique signature associated with a particular program. For example, access to a chat program or a social media application may be controlled by checking the unique signature (i.e., content identifier) of the program in the manners discussed herein. Video games, music, electronic documents, downloadable files and other electronic content may also have unique signatures (i.e., content identifiers).

In one embodiment where the user instance devices store records on whitelists, blacklists and routines for electronic content delivery locally, the server 120 is only contacted for records updates in an ad hoc or predefined fashion.

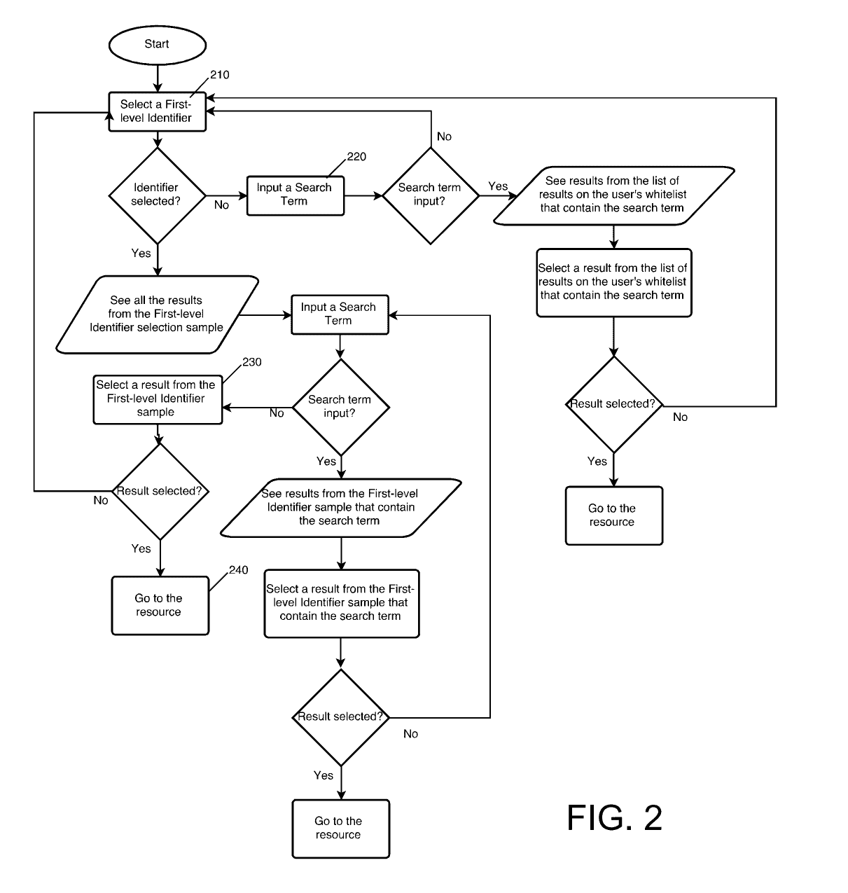

FIG. 2 shows an exemplary flow chart that includes steps taken by a user such as 151, 153, 155, 157 or 159 to access the content that the particular user instance is allowed to. In one embodiment, a user is presented with different subsets of the available electronic content pre-arranged in accordance with certain criteria. Those criteria and pre-arrangement sequences and profiles can be any of: system defined following an automated machine process, system administrator defined, or user defined. Step 210 can refer to a single discrete selection of a subset or, in another embodiment, can be a set of layers and overlays of electronic content identifiers and access restrictions. In one embodiment, upon an affirmative user choice of a First-level Identifier the user is presented with previews of all results that are within the subset defined by the chosen First-level Identifier and are accessible to his/her user instance. The user has further the choice to input a search term through an electronic input device or query a search term as part of an automated process or a workflow (step 220) in the form of keywords or another information piece that can be contained within the available set of results. The subset of available results for which previews are served to the user is determined by the combination of the user choices—First-level Identifier Yes/No and Search based on a Search Term communicated to the server Yes/No. For example, the outcome of a Yes selection on the former (Yes following step 210) and a No selection on the latter (No following step 220) would be a list of previews of all results within the subset defined by the First-level Identifier. The pending action on the latter is depicted in step 230. In one embodiment step 240 and its analogues throughout the system refer to providing the user the access to the electronic resource like opening a web page, a file, etc.

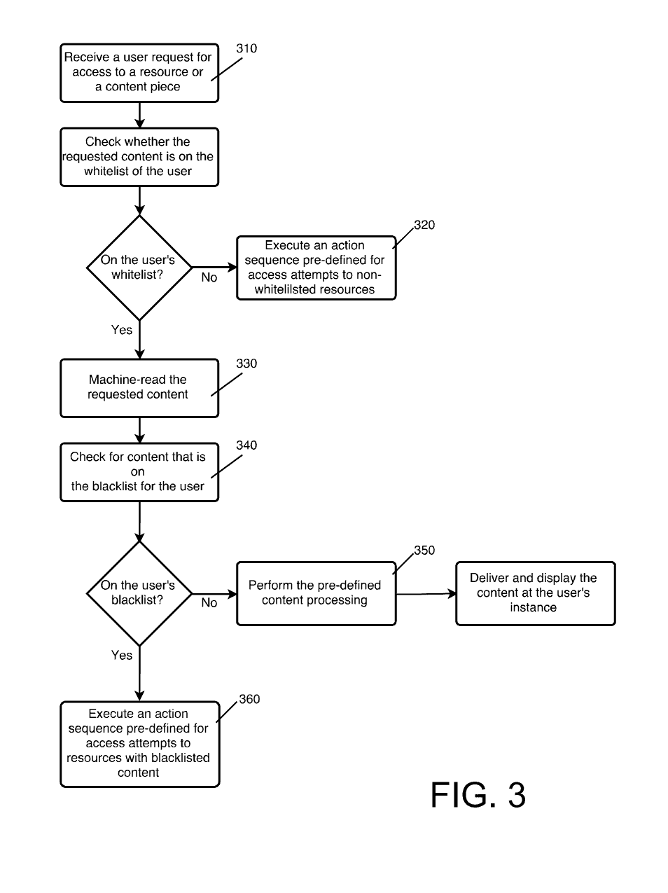

FIG. 3 shows an exemplary flow chart that includes steps executed at the server end for processing a content access request by a user instance and for applying the user-specific whitelist, blacklist and content delivery limitations and provisions stored on the system. In one embodiment, once a user request is identified by the system at the server (step 310) a conformity check is performed on whether the content identifier is part of the set of whitelisting provisions for the user. The resource access request can be for a document preview, opening or download, for opening a webpage or a network resource, for a generic file access or another. If the test is not positive the process goes to step 320 which can refer to any pre-set system action sequence for a particular user. In one embodiment, different action sequences can be linked individually to each user or user group. In another embodiment, the triggers for such user-specific action sequences can further be expanded by adding provisioning by time, by device, by system state, by user or system actions preceding the user request in step 310, or another. In one embodiment, the pre-defined sequence can have the system return the user back to the first step of his/her standard system interaction workflow like a home page on a web application or the first screen after the user login, or to return a pre-defined message without otherwise altering the state of the then—current user interaction. If the test following step 310 is positive the system reads dynamically the requested content (step 330) and checks the blacklists and the content delivery preferences for the user that had submitted the request (step 340). If the requested content contains data pieces, patterns or other identifiable information blocks that are referred to in the user's blacklists the system executes the pre-set system action sequence for the particular user that is triggered by the unique user's attempt to access resources with content identifiable as related to his/her blacklist (step 360). In one embodiment, different action sequences can be linked individually to each user or user group. In another embodiment, the triggers for such user-specific action sequences can further be expanded by adding provisioning by time, by device, by system state, by user or system actions preceding the user request in step 310, or another. If no data pieces, patterns or other identifiable information blocks that are referred to in the user's blacklists are identified within the requested content, the system executes pre-defined content processing routines as set for the particular user instance (step 350) and provides the user with the access to the requested electronic content via opening a web page, opening a file, etc.

The following is an outline of an exemplary non-limited embodiment of the present invention with a non-exhaustive high-level walkthrough of the functionalities. This embodiment refers to a web browser with a search engine functionality where the whitelisted content is assigned in advance to relevance-driven Categories and Groups. A certain resource or web content piece stored at a unique web address can be associated with more than one Category or a group (e.g., the information stored at http://www.nationalgeographic.com/ can be indexed and searchable in categories Geography, History and Science, and in Groups Web and Wiki).

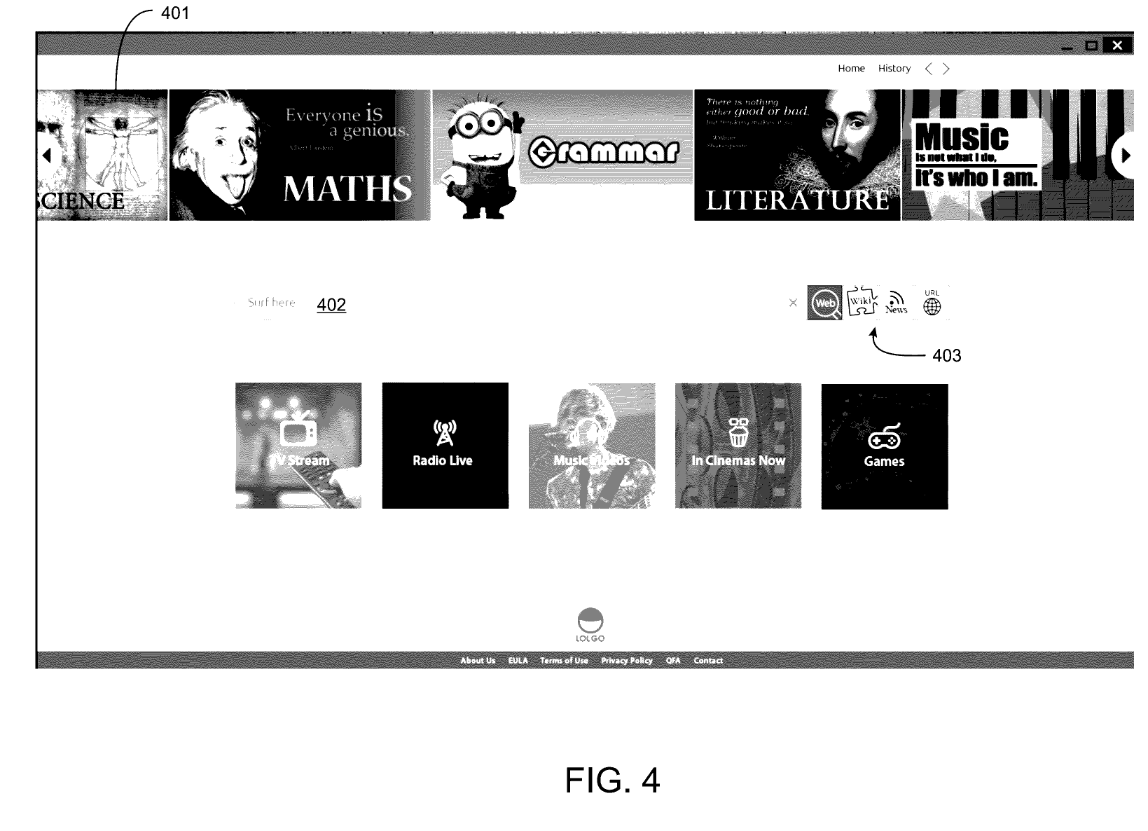

FIG. 4 shows a home page where the user has access to most of the critical functionalities of the search engine and the browser:
a. A carousel CRS1 401 in the upper horizontal area provides access to the content by category (in this example—10 categories following an exemplary curriculum of kids in primary and secondary schools).
b. A search bar 402 which serves for entering keywords and executing a search within the whitelisted results under either a particular category (if such is selected via the CRS1 401 carousel) or a group (by clicking one of the ‘Group’ buttons 403—in this case ‘Web’, ‘Wiki’ and ‘News’) or a combination of a category and a group (category is selected via the CRS1 401 carousel→search terms are entered in search bar 402→a group button is selected from the ‘Group’ buttons 403; the results can be of the type “all results for category ‘Literature’ for group ‘Web’”).
c. In this example the search bar 402 can also serve as a browser URL bar—the user canenter the web address in the search bar 402 and press the ‘URL’ button from the ‘Group’ buttons 403. The URL button works at anytime independent of any other on-screen selection.

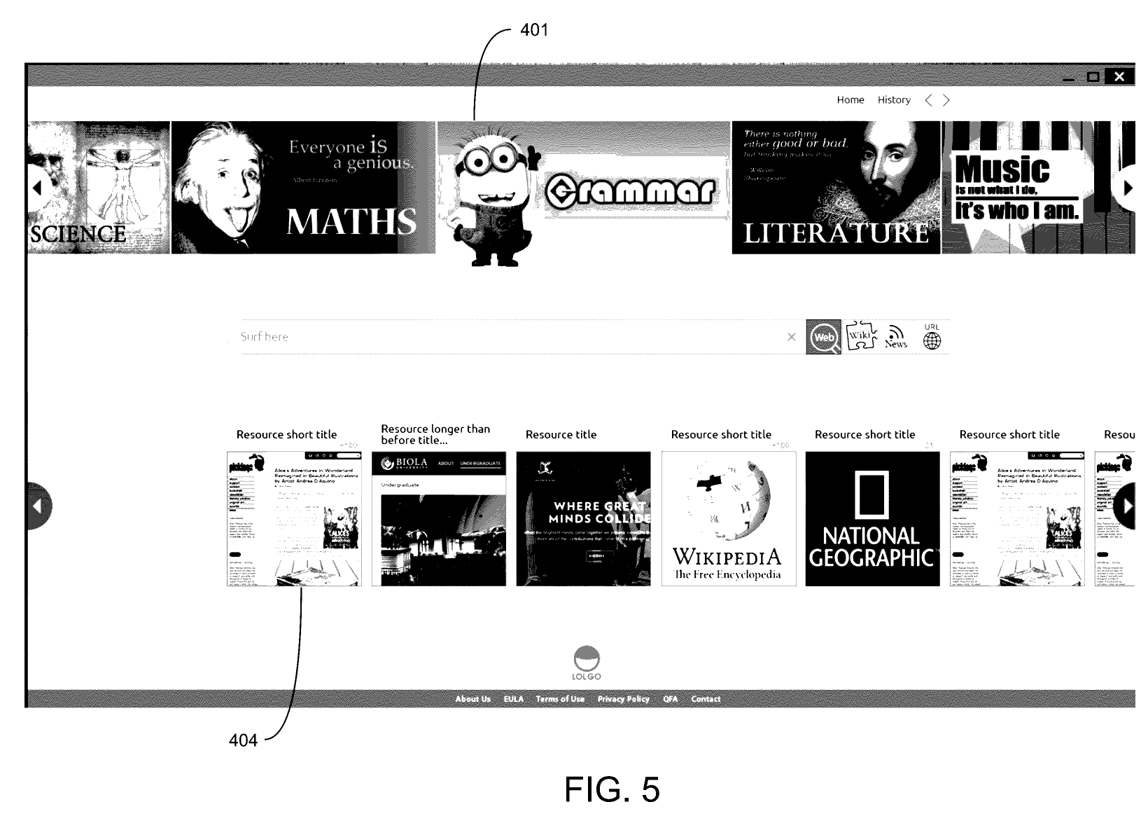

FIG. 5 screen shows results from a selection of a category only (no search term used). Upon clicking on any category item on the CRS1 carousel 401, it remains zoomed in and is positioned in the center. CRS1 stops until the category item is unchecked (unfreezed) by another single mouse click on the same category tile or any other one. When a category is selected via CRS1 without anything activated through the search bar a second horizontal carousel CRS2 404 rolls over the static area with the ‘TV Stream’, ‘Radio Live’ etc. and shows whitelisted results that are also tagged to correspond to the selected category. When a number of individual results are hosted under the same top level domain and in order not to show repetitive results or repetitive result formats, the system groups them by webmaster, a top level domain address or another pre-defined criterion and shows the identifier of the criterion plus the number of results available as per that criterion—this is the case with the first, the fourth and the fifth result from left to right with respective counter values of +100, +100 and 21.

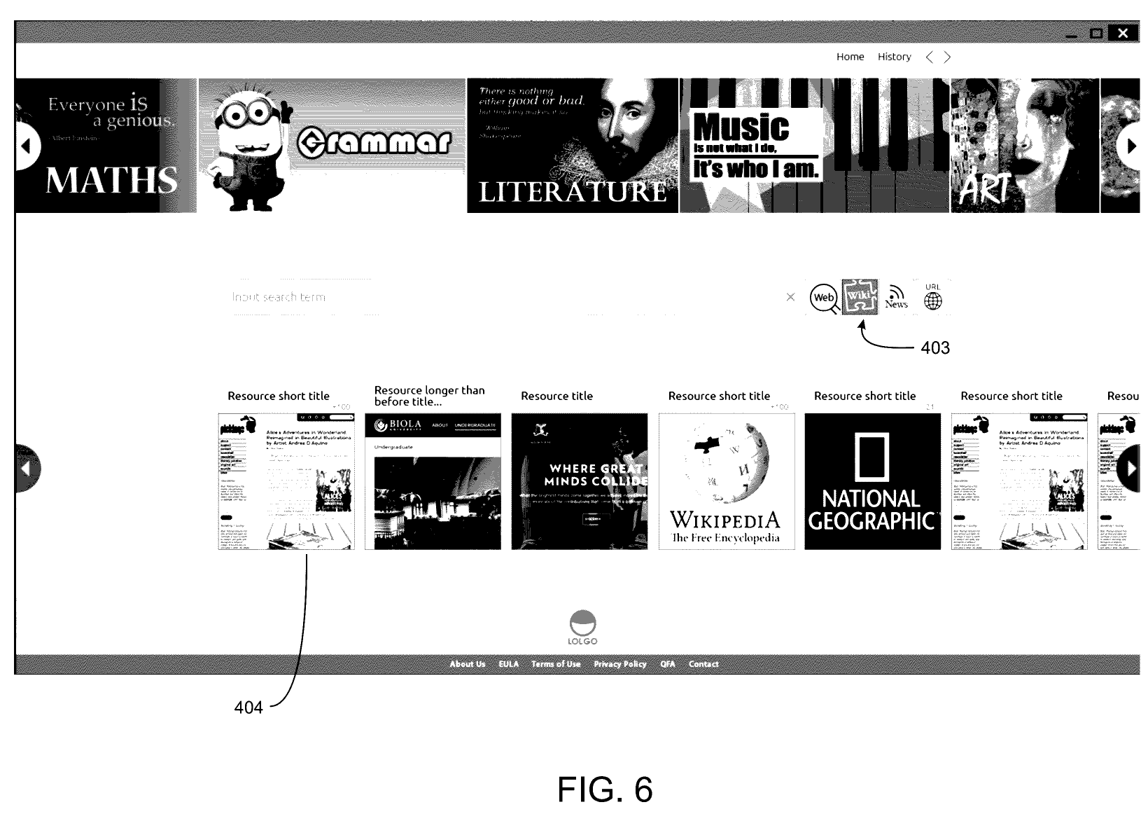

Referring now to FIG. 6, the system would show results in the same way upon a group-only selection, e.g. if no category is selected via the CRS1 401 carousel, no search term is input in the search bar 402, but only one of the ‘Group’ buttons 403 is activated—in this example the ‘Wiki’ group is selected. The results from the ‘Wiki’ group selection are likewise delivered via a second horizontal carousel CRS2 404.

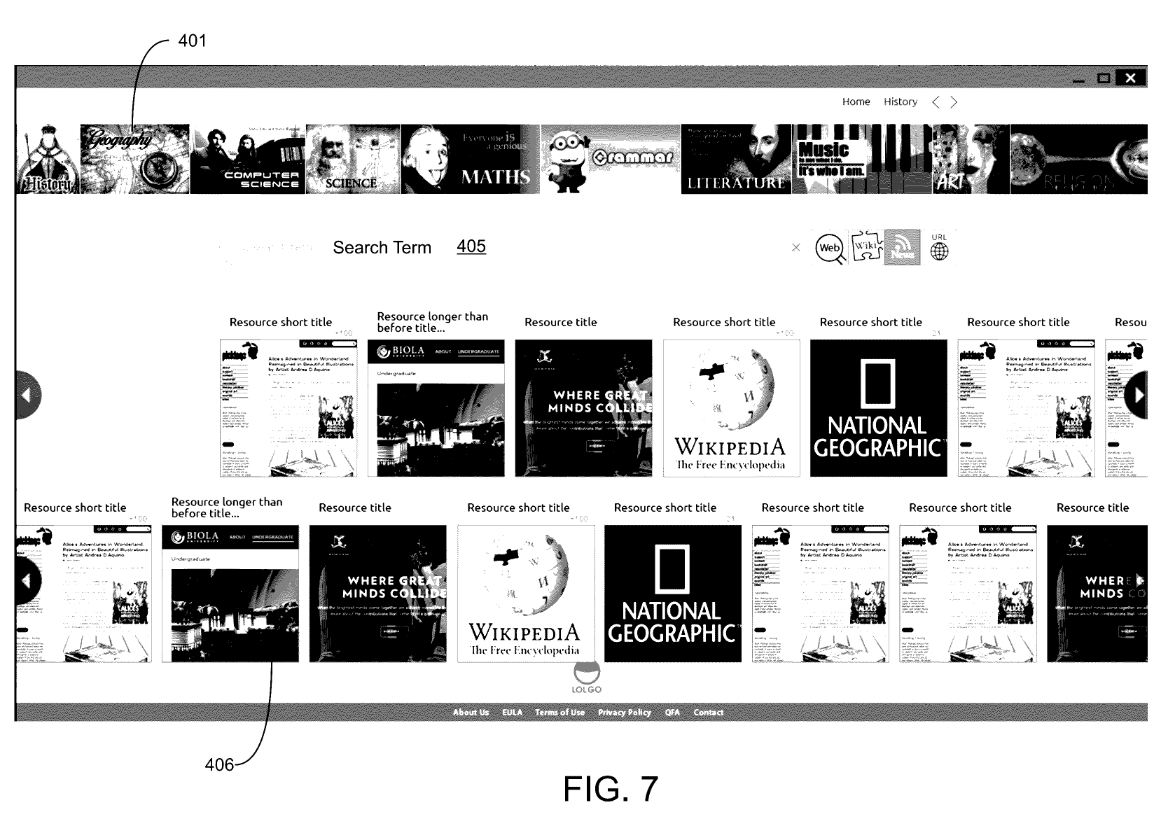

FIG. 7 shows a results list 406 where a search term 405 has been input in the search bar 402. The results are shown in the same fashion with or without a category selection via the CRS1 401 carousel or a group selection the ‘Group’ buttons 403 (i.e. the system will apply the same result list layout to the cases “search term only”, “search term and (within) category”, “search term and (within) group” and “search term and category and group”).

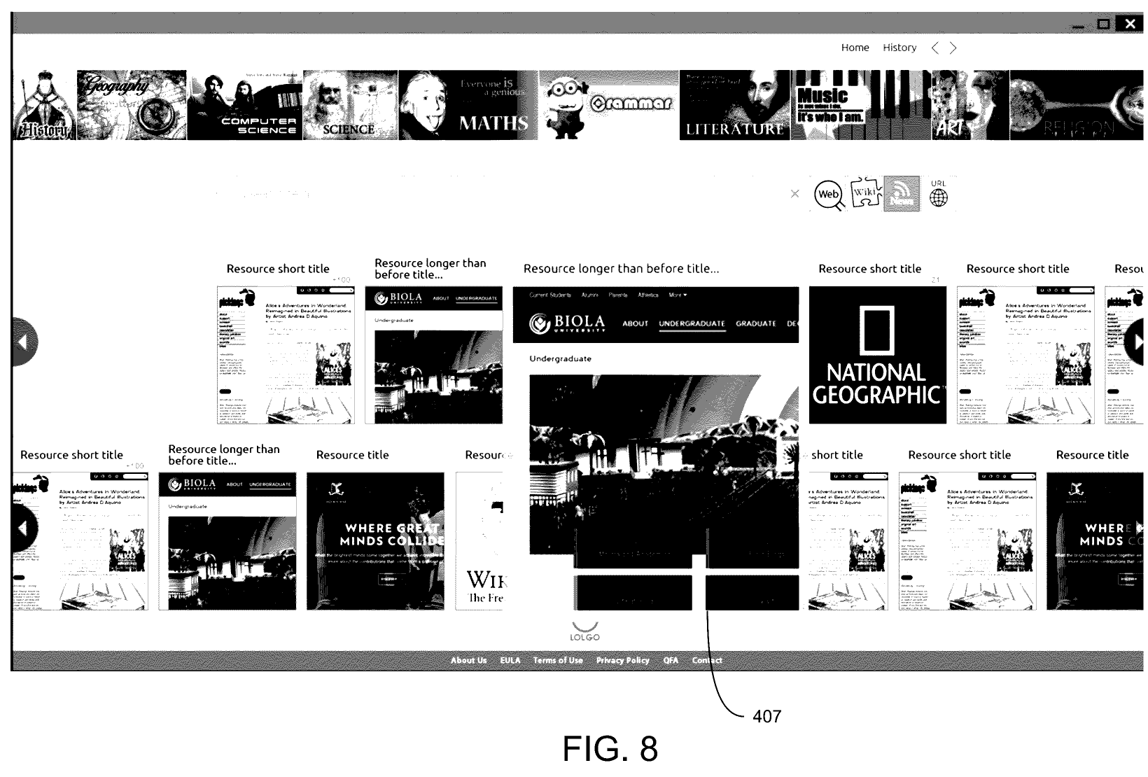

Referring now to FIG. 8, the system allows for providing the user with an enhanced preview 407 (a snippet, a longer description or another administrative or user-defined pre-set visualization) of the results. In this example—this is a popup screen activated upon hovering on a search result tile. A user selection of any search result tile or a popup screen opens the corresponding web page in a new browser tab, the same applies to the URL button click from the ‘Group’ buttons 403.

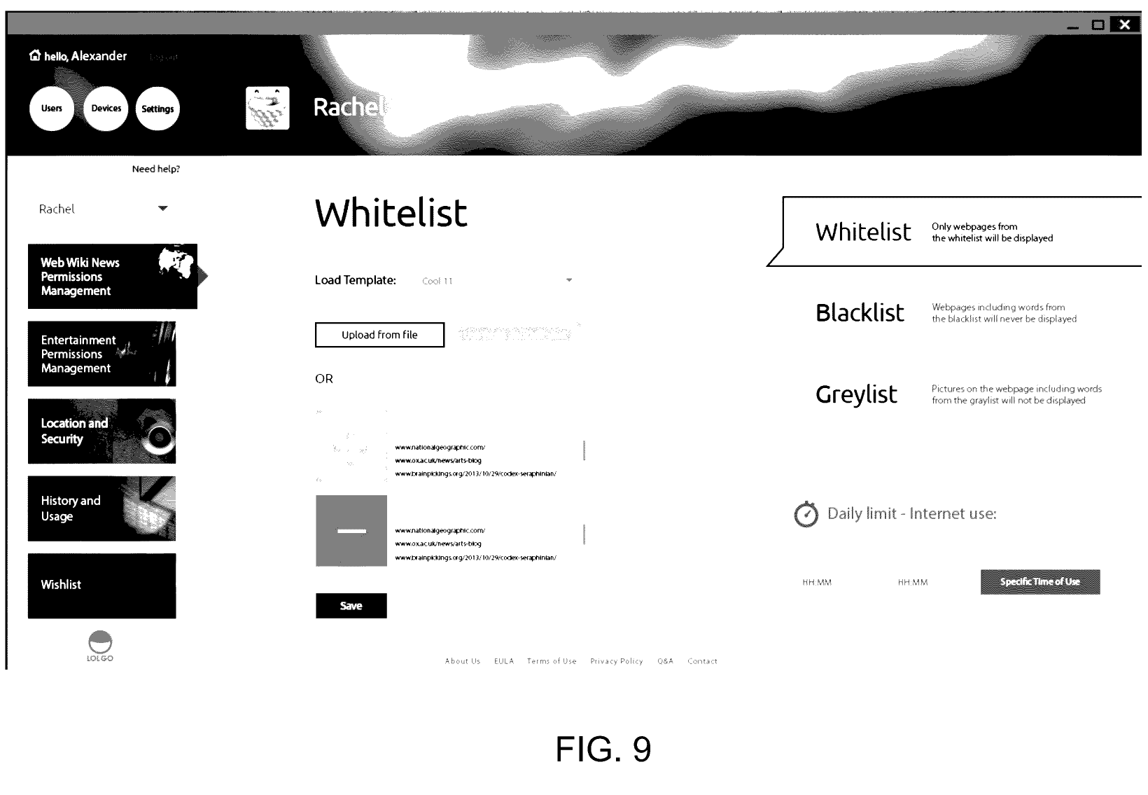

FIG. 9 shows a basic implementation of an end-user control panel. In the context of this example, we have a parent or a guardian (example name: Alexander) who has the rights to setup and modify the whitelists and blacklists of the kids on his/her account (one of those kids in the example is named Rachel). The parent's account is on its own a user instance with specific rights and privileges that propagate on the subordinate accounts of the kids. For the whitelists and the blacklists, the parent or guardian has the options to:
a. choose among pre-defined template lists stored on the system;
b. upload their own list in certain standard formats (e.g. csv, Excel spreadsheet, Unicode txt, etc.)
c. use a list that is already used by another user;
d. modify any of the active lists by adding or removing restrictions; and
e. apply his/her modifications to the user instances of one or more of the kids where he/she has branch administrative privileges. The so-called ‘Greylist’ in this example is a special case of a blacklist with a content visualization sequence attached to it which has the logic “whenever a word or phrase on the greylist is identified on the page, serve only the text content without the graphic components”.

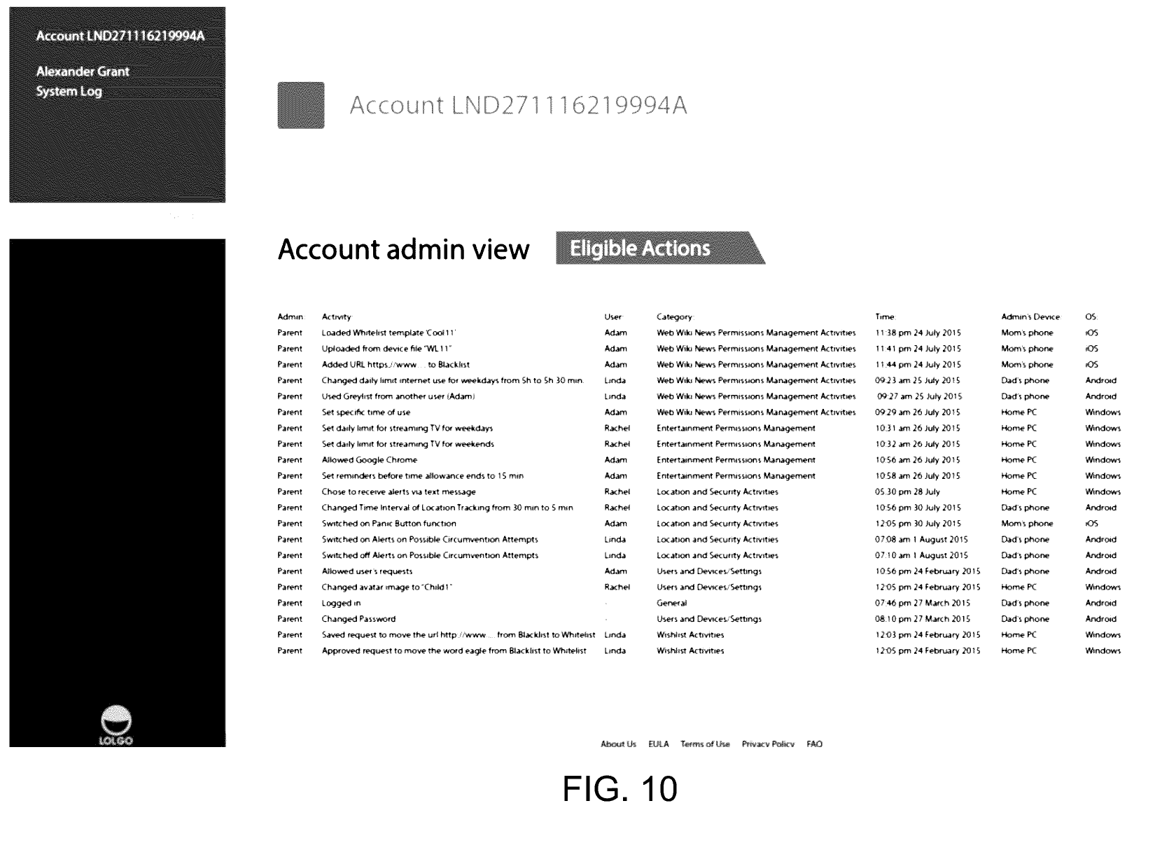

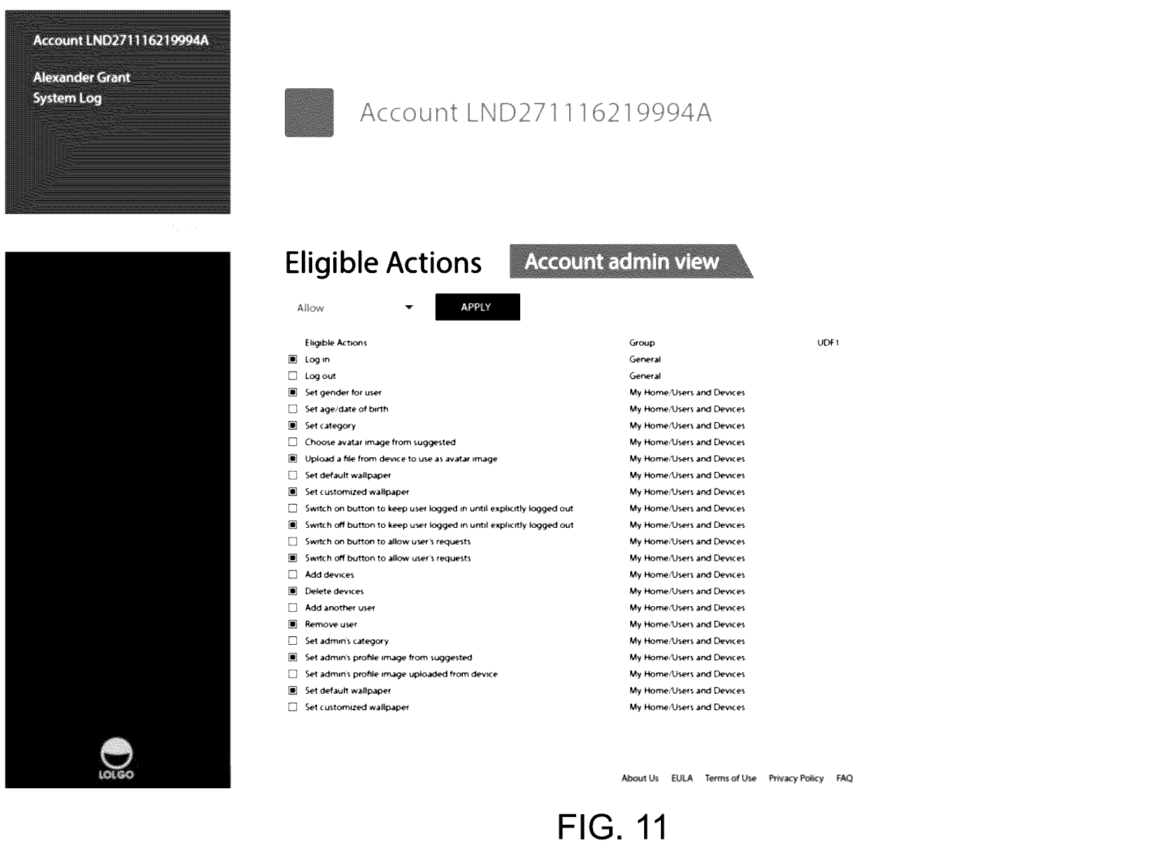

FIGS. 10 and 11 show some functionalities of an administrative panel for a system administrator. FIG. 10 is a full log of a particular parent/guardian user cluster. FIG. 11 shows the management of rights that the particular parent/guardian could have on their subordinated users (kids).

Although the invention has been described in considerable detail in language specific to structural features and or method acts, it is to be understood that the invention defined in the appended claims is not necessarily limited to the specific features or acts described. Rather, the specific features and acts are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated, and can be made without departing from the spirit and scope of the invention.

What is claimed is:

1. A method comprising steps:
(a) receive a request from a user instance for access to identifiable and indexable content, wherein the content is a web resource, an electronic data repository, a document or another uniquely identifiable data piece accessible via electronic networks;
(b) perform a first check whether the content is part of a pre-defined volume of resources which the user instance is allowed to access, wherein the allowed volume of resources is stored and analyzed in the form of one or more whitelists that can be used in provisioned or non-provisioned sets or overlays;
(c) allow the user access to the content only if there is a specific match between the identifier of the content or its repository and an identifier on the whitelists for the user instance;
(d) perform a second check if the user is allowed to access the content, wherein the second check determines if the content is part of a pre-defined set of restrictions applicable to the user instance, wherein the set of restrictions is any piece or volume of identifiable electronic content stored and analyzed in the form of one or more blacklists or blacklist routines that can be used in provisioned or non-provisioned sets or overlays; and
(e) apply content pre-processing and deliver the content as prescribed by a general pre-defined settings for content delivery, format, and visualization to the user applicable to the particular user instance.

2. The method of claim 1, further comprising step (f) deny access to the content as prescribed by the one or more blacklist routines when the user is not allowed access to the content as performed by the second check.

3. The method of claim 1, in step (a), wherein the user instance is a set of user preferences, routines, and credentials linked to a particular individual, end user device, computer system, network device, identifiable network, or cluster.

4. The method of claim 1, further comprising step (g) allow the user instance visibility and access only to indices, summary information, snapshots, resumes or snippets of the content that is on the user's one or more whitelists if any type of a search functionality is used.

5. The method of claim 1, wherein the one or more whitelists and blacklists are pre-defined by a user, a system, an application administrator, or by a computer process executing a set of routines that are a programmatic implementation of objective and subjective criteria for content identification, analysis, sorting, and filtering.

6. The method of claim 1, wherein the request results can be grouped by dynamic or pre-defined criteria for context, type, geography, chronology, language, or another criterion defined by a user, by an administrator or by a machine setting, process or workflow.

7. A system comprising:
a Network-connected server containing a processor capable of executing instructions stored on a computer-readable storage medium, the processor executing end user software tools for allowing managed access to electronic content, the system enabling a user via an electronic device to:
(a) select a First-level identifier, wherein a first list of results is presented based on the First-level identifier selection;
(b) input a search term through an electronic input device, wherein a second list of results is presented;
(c) select a result from the first or second list of results; and
(d) access the electronic content from the selected result.

8. The system of claim 7, wherein the second list of results is the first list of results that contain the search term.

9. The system of claim 7, wherein the second list of results is the user's whitelist that contain the search term.

10. The system of claim 7, wherein the first and/or second list of results contain the search term or summary information, snapshots, resumes, or snippets from the first and/or second list of results only from content that is on the user's one or more whitelists.

11. The system of claim 7, wherein the electronic device includes a second processor capable of executing instructions stored on a second computer-readable storage medium, and the electronic device are subject to system restrictions.

12. The system of claim 11, wherein the second computer-readable storage medium stores records on whitelists, blacklists, and routines for the access to the electronic content, and the system checks the second computer-readable storage medium to see if the user is allowed or denied access to the electronic content.

13. The system of claim 7, wherein the first computer-readable storage medium stores records on whitelists, blacklists, and routines for the access to the electronic content, and the system checks the first computer-readable storage medium to see if the user is allowed or denied access to the electronic content.
